(19) United States
(12) Patent Application Publication
(10) Pub. No.: US 2020/0236254 A1
(43) Pub. Date: Jul. 23, 2020

(54) CAMERA SYSTEM WITH REDUCED ALIGNMENT SHIFT

(71) Applicant: Black Sesame International Holding Limited, Santa Clara, CA (US)

(72) Inventor: Kuochin Chang, Cupertino, CA (US)

(73) Assignee: Black Seasme International Holding Limited

(21) Appl. No.: 16/255,150

(22) Filed: Jan. 23, 2019

(51) Int. Cl. H04N 5/225; H04N 5/247

(52) U.S. Cl. CPC H04N 5/2253; H04M 1/0264; H04N 5/247

(57) ABSTRACT

An alignment shift reduction system having, a plurality of camera modules, an L-shaped flex cable coupled to the plurality of camera modules and a unified attachment area coupled to the plurality of camera modules.

### BACKGROUND

### Technical Field

The instant disclosure is related to a camera system, more specifically to a camera system having at least one camera module with reduced alignment shift.

### Background

The camera in a mobile phone is placed so that the camera's view is not blocked by the cover of the phone. In the event that the mobile phone is dropped, what is sought is that the position of the camera remains un-shifted from its original position. This implies that the mobile phone provides sufficient structural rigidity to the camera module so that the camera module remains stationary in the event of an impact. A rigid mechanical retention system is especially important in a multiple camera module. In a pre-calibrated multiple camera module, if a camera is shifted, the calibration data may change due to the force applied to the module, where the camera module would require recalibration.

Currently, when a multiple camera module is produced and built into a mobile phone, a calibration process is applied. If the cameras optical centers are not correctly aligned, the calibration process will fail and the camera module may not function correctly. When a module is installed into a mobile device, mechanical force is applied between the mobile device and a mating surface of the camera module. If an applied force is large enough to shift the camera module from its original position, the original calibration information may contain errors. The mobile device may then need to be recalibrated or the camera module may need to be replaced.

### SUMMARY

In one embodiment, an alignment shift reduction system having, a plurality of camera modules, an L-shaped flex cable coupled to the plurality of camera modules and a unified attachment area coupled to the plurality of camera modules.

In another embodiment, an alignment shift reduction system having, a plurality of camera modules, an elongated L-shaped flex cable coupled to the plurality of camera modules and a frame attachment area coupled to the plurality of camera modules.

In yet another embodiment, an alignment shift reduction system having, at least one camera module, a plurality of L-shaped flex cables coupled to the at least one camera module, wherein a length of one of the plurality of the flex cables is greater than twice a span of the at least one camera module and a frame attachment area coupled to the at least one camera module.

### DESCRIPTION OF THE DRAWINGS

FIG. 1 is a first example of a dual camera system with a unified frame in accordance with one embodiment of the disclosure;

FIG. 2 is a first example of a single camera system in accordance with one embodiment of the disclosure;

FIG. 3 is a second example of a single camera system with multiple flexible connector in accordance with one embodiment of the disclosure;

FIG. 4 is a third example of a single camera system with a single L shaped flexible connector in accordance with one embodiment of the disclosure;

FIG. 5 is a fourth example of a single camera system with an in plane and two plane L shaped connector in accordance with one embodiment of the disclosure;

FIG. 6 is a fifth example of a single camera system with an in plan L shaped connector with torque in accordance with one embodiment of the disclosure;

FIG. 7 is a sixth example of a single camera system exploded view in accordance with one embodiment of the disclosure:

FIG. 8 is a second example of a dual camera system with a unified frame in accordance with one embodiment of the disclosure;

FIG. 9 is a third example of a dual camera system with a unified frame in accordance with one embodiment of the disclosure;

FIG. 10 is a third example of a dual camera system with a unified frame in accordance with one embodiment of the disclosure; and

FIG. 11 is a fourth example of a dual camera system with a unified frame and a unified connector in accordance with one embodiment of the disclosure.

### DETAILED DESCRIPTION OF THE INVENTION

The embodiments listed below are written only to illustrate the applications of this apparatus and method, not to limit the scope. The equivalent form of modifications towards this apparatus and method shall be categorized as within the scope the claims.

Certain terms are used throughout the following description and claims to refer to particular system components. As one skilled in the art will appreciate, different companies may refer to a component and/or method by different names. This document does not intend to distinguish between components and/or methods that differ in name but not in function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device that connection may be through a direct connection or through an indirect connection via other devices and connections.

A camera module is composed of a flexible flat cable connected to a substrate, a sensor connected to the substrate, an optical filter positioned above the sensor, a holder, and lens. The flexible flat cable, substrate, sensor, and filter are often securely integrated. An integrated module can sustain a large force without shifting from its original position. However, the holder and lens are not firmly connected to one another. That is, if a force is applied to the flat printed circuit, then the sensor and filter may shift more than the lens holder. Additionally, if a force is applied to the lens holder, the focal plane may become angle shifted compared to its original focal plane.

One example system may group several camera modules together to form a multiple camera module by adhering multiple individual camera holders to a rigid frame or adhering individual camera substrates together. When installing a multiple camera module into a phone, a flexible flat cable may be connected to a printed circuit board (PCB) mother board at one end and a camera module at another end where force is exerted on the camera module through the flexible flat cable. Additionally, a camera module may be in contact with a phone cover and may receive an applied force that is transmitted from the cover to the frame of the phone and the camera module. Therefore, a portion of the force may be passed to the camera module through the flexible flat cable, holder, or frame. This unexpected force may cause the center of the sensor and the lens optical center to off-shift which may cause calibration errors.

The flexible flat cable is comprised of flexible plastic that covers a series of thin metal signal wires. The wires produce very little compressive or tensile stress compared to the plastic. That is, most of the flexible flat cable force is delivered from the plastic to the sensor which may induce a shift between the sensor and the lens.

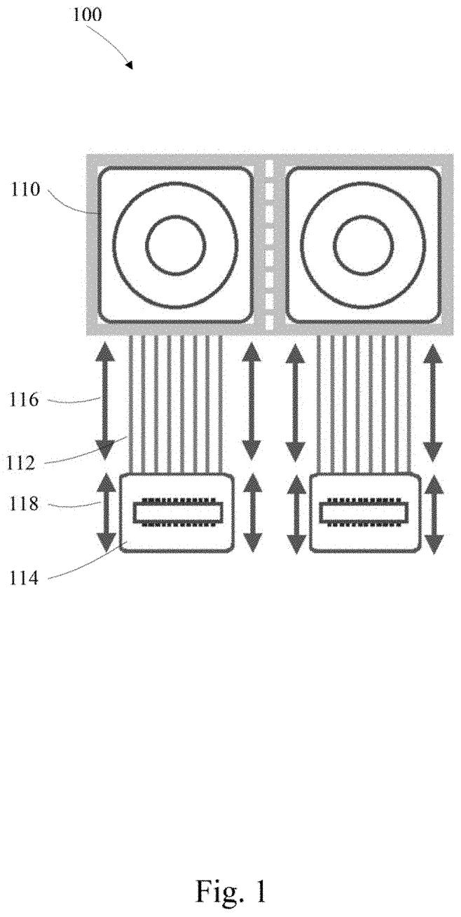

FIG. 1 shows a first example of a dual camera system with a unified frame 110, if the flexible flat cable connector 112 and camera holder are aligned in one dimension, the tensile or compressive stress 118 on the connector 114 in the plane of a board to which an optical sensor is connected may be passed from the flexible flat cable to the substrate 116 and sensor due to the fact that the flexible flat cable cross section area delivers a force to the substrate and sensor.

F(force)=σ(coefficient)×A(area)

Therefore, reducing either the force or the contact area will reduce the force applied to off-shift the sensor and lens.

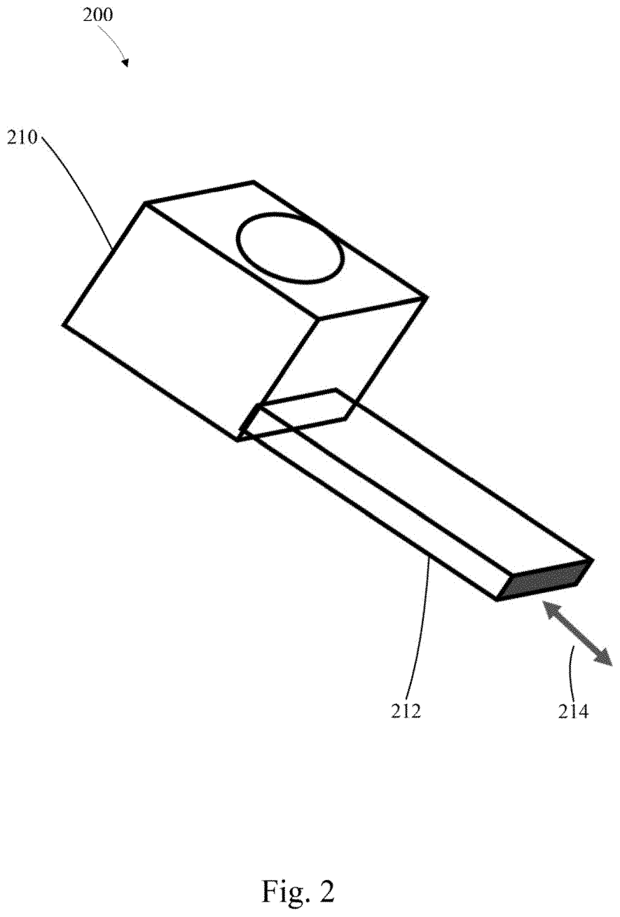

FIG. 2 shows a camera module 210 having a flex cable 212 connected to it. Force is transmitted in tension or compression 214 to the end of the flex cable in the same plane as the board to which the optical sensor is connected.

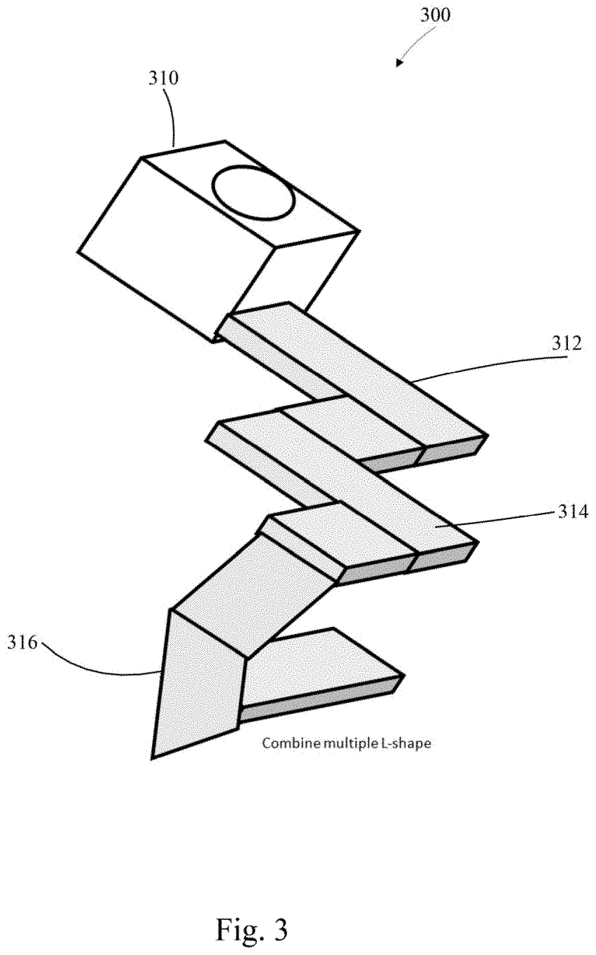

One way to reduce induced force is to configure a flexible flat cable connected to the camera module in an L-shape. If a force is applied to the end of the cable, the flexible flat cable bends may bend in multiple directions which mitigates the force received through the cable at the camera module. Depending on the angle of force applied to the flexible flat cable, the force may be reduced. Also, combining multiple L-shape flexible cables may further reduce the force transmitted from the cable to the camera module. FIG. 3 shows a single camera system 310 with multiple flexible connectors 312, 314 and 316. The force transmitted through an L-shaped connector may take the form shown below.

F′=cos(θ)×F

However, F′ cannot be forced to 0 even in a 90° case because flexible flat cable transmits an elastic force. This elastic force generates three new dimensional forces (F′, F″, F′″). The transmitted elastic force is thus related to ΔL.

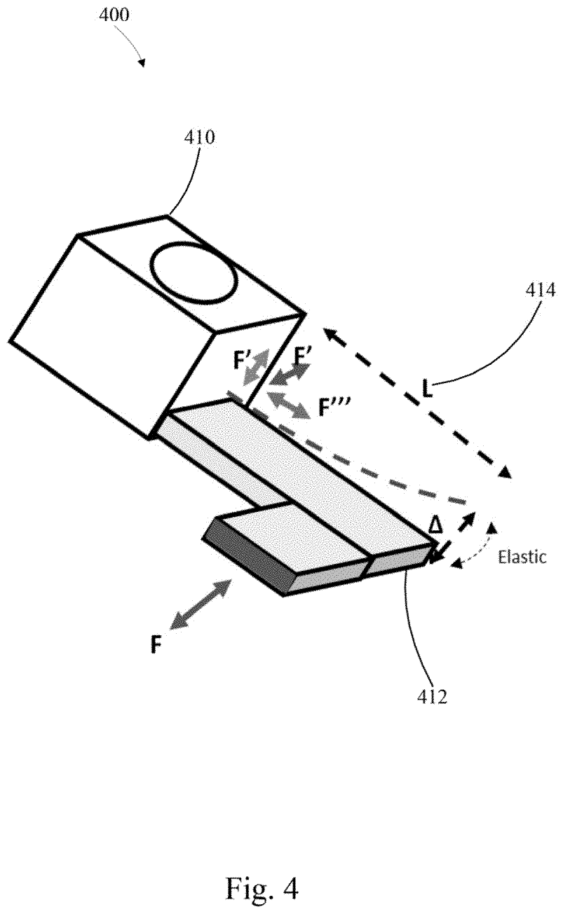

FIG. 4 depicts a camera module 410 with an L-shaped connector 412 in which a force is applied in a direction orthogonal to the end of the cable and the plane of the connector, a bending moment induces a movement of delta to the cable over the length L 414 of the cable.

E(elastic force)=k(coefficient)×ΔL

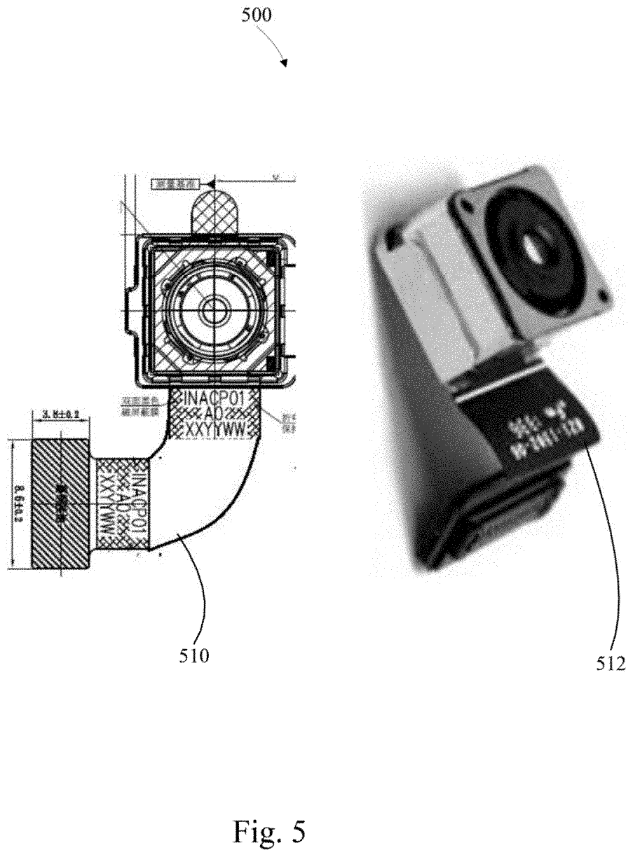

Therefore, reducing ΔL is also important. If the force is constant, the longer the flexible flat cable length (L), the lower the induced elastic force. Another way to reduce the induced force is to build the cable in such a way as to induce a moment (bend) to the cable in the Y dimension instead of Z dimension. FIG. 5 depicts two connectors having an L-shape, 510 depict a planar L-shaped flex cable and 512 depicts a cable in which the L-shape is built into the cable in two planes.

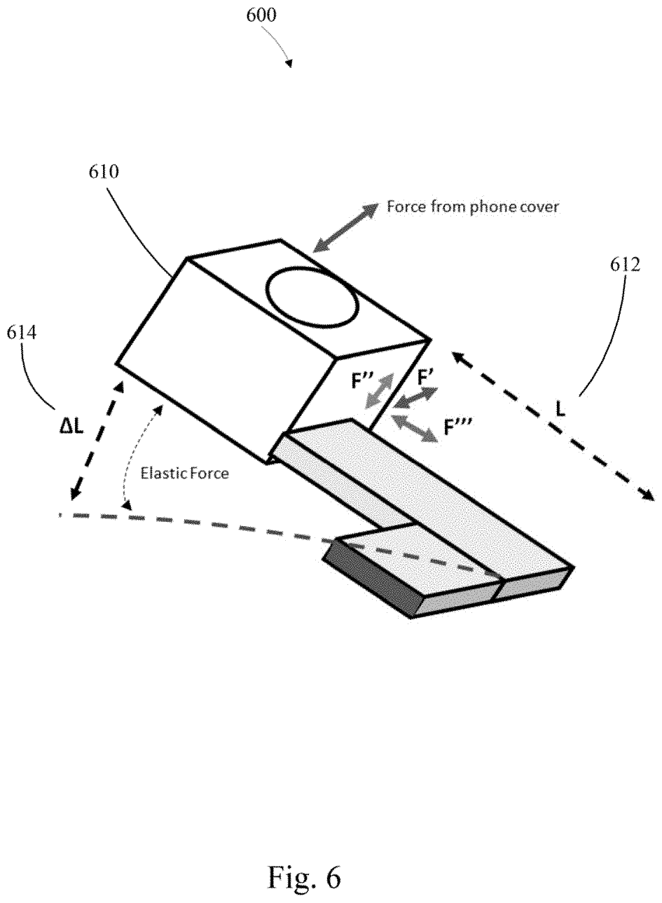

One method to reduce induced force is to reduce or remove contact between the phone cover and the camera module. If contact is necessary to enhance the stability of photo capture experience, then alternatively, increasing the length of the flexible flat cable, reduces ΔL caused by elastic force. FIG. 6 depicts a camera module 610 that receives a force input from a phone cover which results in a movement delta L 614 along the length of the in plane L shaped flex cable L 612.

One previous method to try to reduce force induced by the flexible flat cable is by gluing the flexible flat cable on frame. However, this method shortens L which may induce a larger elastic force.

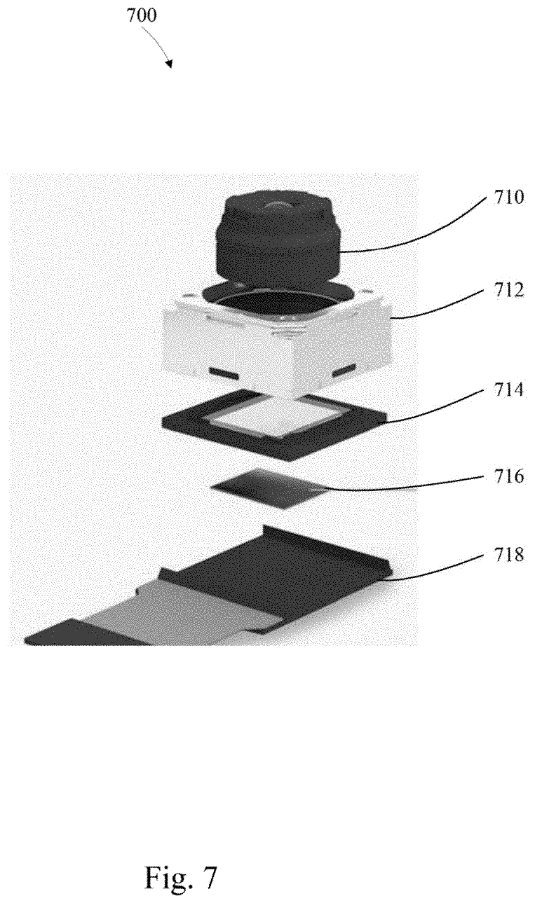

FIG. 7 depicts an exploded view of a camera module having a lens 710 supported by a frame 712 having a connector board 714 holding an optical sensor 716 which is connected to a flat flex cable 718.

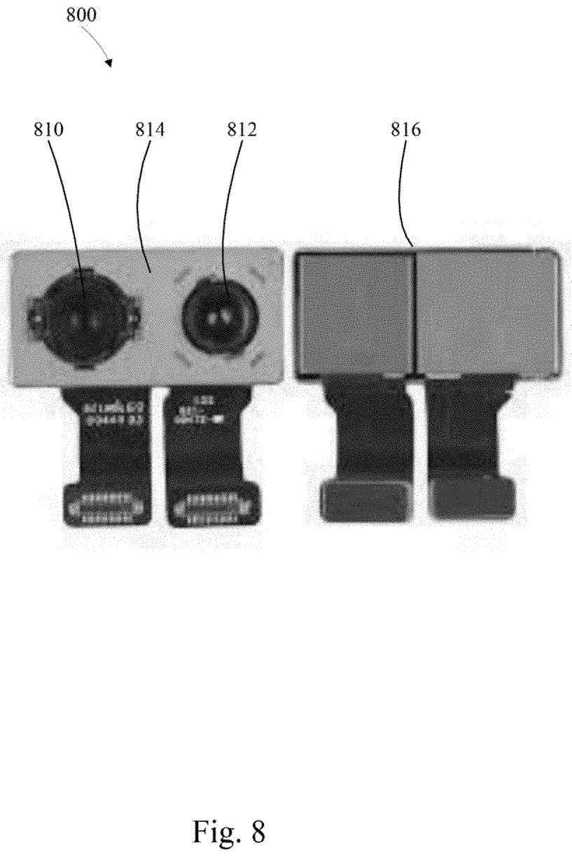

FIG. 8 depicts a dual camera system having a first camera 810 and a second camera 812 held in place by a unitary frame front 814 having side edges 816.

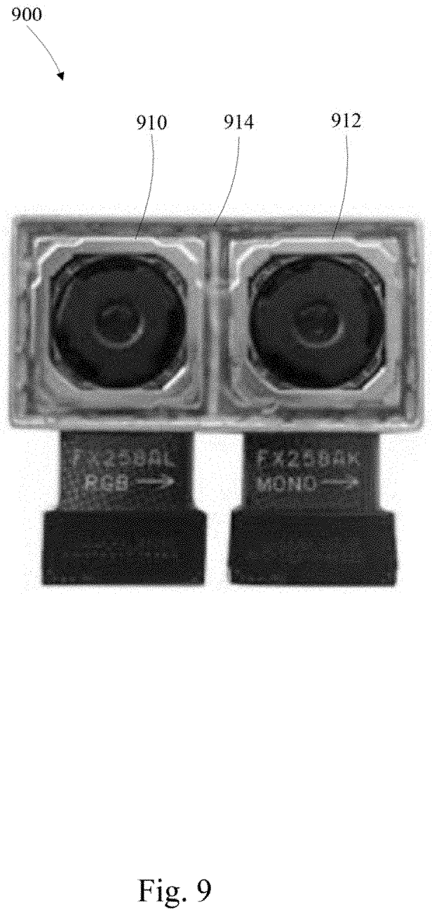

FIG. 9 depicts another dual camera system having a first camera 910 and a second camera 912 held together by a unitary frame 914.

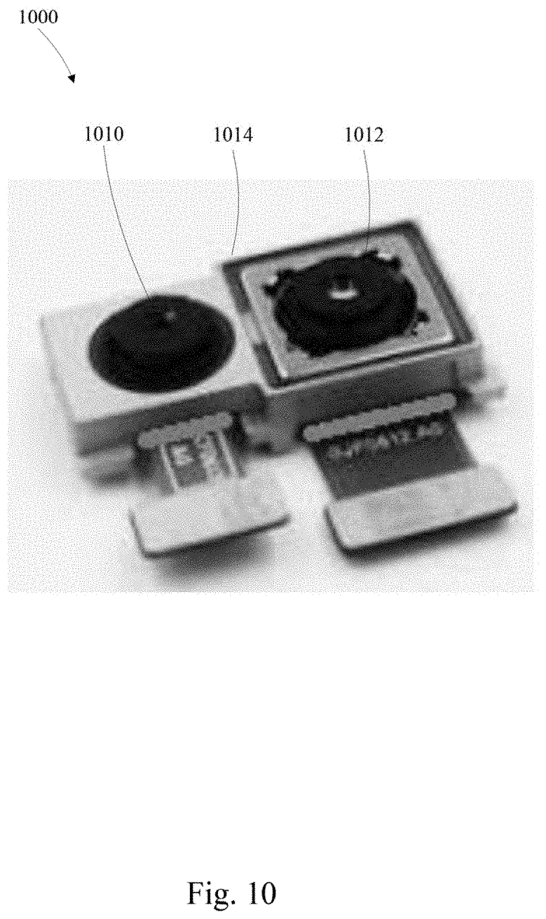

FIG. 10 depicts yet another dual camera system having a first fixed focus camera 1010 and a variable focus camera 1012 held together by unitary frame 1014.

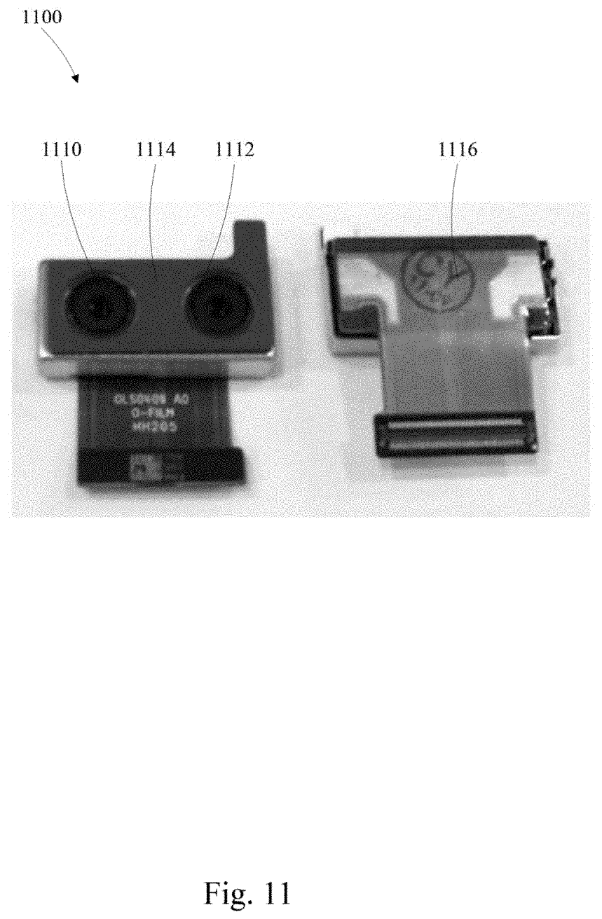

FIG. 11 depicts yet another dual camera system having a first camera 1110 and a second camera 1112 held together by a unitary frame 1114 and having a unitary flex cable 1116.

In multiple cameras systems, regardless whether the individual cameras are glued to the lens holder or substrate, a force applied to the frame or substrate may be evenly distributed between the cameras. A larger frame area or substrate area may more evenly spread the force between the cameras instead of inducing the force on an individual camera.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment. In conjunction with the present disclosure, those skilled in the art will be able to design and incorporate any one of the variety of mechanisms suitable for accomplishing the above described functionalities.

It is to be understood that the disclosure teaches just one example of the illustrative embodiment and that many variations of the invention can easily be devised by those skilled in the art after reading this disclosure and that the scope of then present invention is to be determined by the following claims.

What is claimed is:

1. An alignment shift reduction system comprising:
a plurality of camera modules;
an L-shaped flex cable coupled to the plurality of camera modules; and
a unified attachment area coupled to the plurality of camera modules.

2. The alignment shift reduction system of claim 1 wherein a length of the flex cable is greater than twice a span of one of the plurality of camera modules.

3. The alignment shift reduction system of claim 1 further comprising an additional flex cable coupled to the L-shaped flex cable.

4. The alignment shift reduction system of claim 1 wherein the unified attachment area is a frame.

5. The alignment shift reduction system of claim 1 wherein the flex cable is formed in one plane.

6. The alignment shift reduction system of claim 1 wherein the flex cable is formed in two planes.

7. The alignment shift reduction system of claim 1 wherein the plurality of camera modules is two cameras.

8. An alignment shift reduction system comprising:
a plurality of camera modules;
an elongated L-shaped flex cable coupled to the plurality of camera modules; and
a frame attachment area coupled to the plurality of camera modules.

9. The alignment shift reduction system of claim 8 wherein the flex cable is formed in one plane.

10. The alignment shift reduction system of claim 8 wherein the flex cable is formed in two planes.

11. The alignment shift reduction system of claim 8 further comprising an additional flex cable coupled to the L-shaped flex cable.

12. The alignment shift reduction system of claim 8 wherein the plurality of camera modules is two cameras.

13. An alignment shift reduction system comprising:
at least one camera module;
a plurality of L-shaped flex cables coupled to the at least one camera module,
wherein a length of one of the plurality of the flex cables is greater than twice a span of the at least one camera module; and
a frame attachment area coupled to the at least one camera module.

14. The alignment shift reduction system of claim 13 wherein one of the plurality of flex cables is formed in one plane.

15. The alignment shift reduction system of claim 13 wherein one of the plurality of flex cables is formed in two planes.

16. The alignment shift reduction system of claim 13 wherein the at least one camera module is two cameras.
